(19) United States
(12) Patent Application Publication
(10) Pub. No.: US 2021/0226463 A1
(43) Pub. Date: Jul. 22, 2021

(54) Portable Power Supply Device and Managing Method Thereof

(71) Applicant: Shen Zhen Deto Electronic Co., Ltd., Shenzhen, Guangdong (CN)

(72) Inventors: Peng ZHANG, Shenzhen (CN); Wenqiang LI, Shenzhen (CN)

(21) Appl. No.: 16/304,162

(22) PCT Filed: Sep. 21, 2018
(86) PCT No.: PCT/CN2018/106877

§ 371 Date: Nov. 22, 2018

(51) Int. Cl. H02J 7/00; H02J 50/10; H02J 1/10

(52) U.S. Cl. CPC H02J 7/0063; H02J 1/10; H02J 50/10

(57) ABSTRACT

A portable power supply device includes a control module, an input module and a load module, wherein the input module is controlled by the control module to obtain electrical power to be supplied to the load module. A connection and disconnection from the input module to the load module and a connection inside the load module are controlled by the control module according to the detection of the input module and the load module. And, a portable power supply managing method is provided so that the external device with different types of charging ports is able to be charged according to the charging demand, wherein even a non-wirelessly chargeable external device can be charged with electrical power in a wireless manner, without the need to updating any external charging hardware to the external device.

### CROSS REFERENCE OF RELATED APPLICATION

This is a U.S. National Stage under 35 U.S.C. 371 of the International Application Number PCT/CN2018/106877, filed Sep. 21, 2018.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to an electrical power device, and more particularly to a portable power supply device that provides electric energy to an external electrical device.

### Description of Related Arts

Daily life is tightly companied with electrical devices, such as smart phones, laptops, noise-cancelling headphones, activity trackers, and so on. These electrical devices are all powered and serviced by batteries. And, with more advance technology or functional application, the battery equipped inside the electrical device is generally desired to have a larger capacity, or it will likely be drained out with electrical power during usage. The most efficiency way to solve power running out shortcoming is to recharge it in a timely manner. However, even, for example, turning on the power saving mode of the electrical device and the like cannot solve such problem fundamentally. In order to maintain the electrical devices being used freely anytime and anywhere, charging accessories, such as charging lines, backup batteries or power supplies, are necessary to be carried and companied with the electrical devices.

However, as shown in FIG. 1, the conventional electrical devices are respectively and typically arranged with different standard charging ports. Electrical devices owned by the same person usually do not have universal charging ports, and are hardly to have the same kind of charging port. Furthermore, the technology of the charging ports of different electrical devices is keep upgrading, such as from Micro USB to Type-C and from Apple 30-pin To Apple lightning. With the development of the technology, the charging port has also innovated into different types. Recently, wireless charging technology becomes popular, so the charging port, charging agreements and charging devices become more diverse to be adaptable for wireless charging. Although various types of charging port are provided and the charging efficiency has some improvement too, charging ports in different types require different charging devices to be carried elsewhere, that causes a lot of trouble. For example, someone may have a smart phone and a Bluetooth headphone therefor while its charging port may usually not the same type of the charging port with the smart phone, so that he/she has to prepare and carry two charging lines of different kinds. In order to be to use more electrical devices with different functions, multiple kinds of charging device are required to be carried with those electrical devices.

Some charging lines each provides a converter or an attaching converting port, while some charging lines each provides a plurality of sub-lines with different types of charging port to solve this problem. However, the charging lines have to be used with the portable power supply which should have corresponding charging ports for providing electrical power to the electrical devices. Converters or attaching convert ports are easy to lose or damaged. In addition, charging via a plurality of sub-lines with only one charging line will decrease the transmission efficiency of electrical power. Also, they cannot be adapted for wireless charging technology.

The conventional portable power supply may provide charging power similarly as stationary external power source. However, the simultaneous access of the portable power supply with the electrical device and the external power source may cause problems. The conventional portable power supply is receiving electrical power from the external power and providing electrical power to the electrical device at the same time, which can cause adversely affect to the battery(ies) of the portable power supply. And, the efficiency of power receiving from the portable power supply is less than receiving from the external power source directly. In situations of the electrical devices capable of being wireless charged or wired charged from the external power source, the portable power supply does not necessary at all, which reducing energy transmission efficiency. It is simply an extra supply for charging the electrical devices to use the portable power supply, but the extra battery cannot be serviced along with the external power source.

Moreover, the charging port is likely to be gradually replaced by the wireless charging hardware. Wireless charging can partially solve the problem of dealing with noncomparable charging ports. However, wireless charging technology still has a lot of unsolved physical limitations. One of the problems is that wireless charging is necessary to ensure an extremely short distance between the electrical device and the external power source. Another problem is that the power transmission efficiency of the wireless charging, without energy transferring medium, is lower than the wired charging.

Currently, the wireless charging has to receive electrical power from the wired external power source which is then transmitted to the electrical device placed on the charging surface of the wireless charging hardware. Since a length of wire connecting the wireless charging hardware with the external power source is limited, the wireless charging hardware cannot be placed or moved anywhere as desired. Also, it is inconvenient to be moved around. Also, some clip-type movable power supplies or backup batteries are capable of being moved around but, while connecting with the electrical device, it will directly increase the distance between the electrical device and the wireless charging hardware. Therefore, the conventional wireless charging cannot work well to transmit electrical power or can merely work in very low efficiency.

Above mentioned problems of supplying power for the electrical device are required to be solved for certainly facilitating lives and using the electrical devices freely.

### SUMMARY OF THE PRESENT INVENTION

The invention is advantageous in that it provides a portable power supply device and managing method thereof, wherein the electrical power to be supplied to an external device is able to be selected from a wireless manner and a wired manner.

Another advantage of the invention is to provide a portable power supply device and managing method thereof, wherein external devices with different types of charging ports are all able to be charged according to the charging requirement thereof.

Another advantage of the invention is to provide a portable power supply device and managing method thereof, wherein portable electrical power is supplied for a wirelessly chargeable external device without maintaining the external device at a fixed position.

Another advantage of the invention is to provide a portable power supply device and managing method thereof, wherein the non-wirelessly chargeable external device can also obtain electrical power in a wireless manner, without updating the external charging hardware to the external device.

Another advantage of the invention is to provide a portable power supply device and managing method thereof, wherein adaption of the power source in a wireless manner or a wired manner with the external device is improved, while ensuring the electrical power transmission efficiency.

Another advantage of the invention is to provide a portable power supply device and managing method thereof, wherein a wireless manner and a wired manner are able to be selected with reasonable competition manner to supply electrical power without interfering with each other and to avoid mutual power backflow between the wireless manner and the wired manner.

Another advantage of the invention is to provide a portable power supply device and managing method thereof, wherein two operating modes are provided, including a loading mode and a supplying mode, wherein during the loading mode, the external device is connected and to be charged preferentially rather than an internal battery, wherein during the supplying mode, the external device is charged with electrical power from the internal battery, so that the external device can be supplemented by electrical power during different modes in a timely manner.

Another advantage of the invention is to provide a portable power supply device and managing method thereof, wherein the wirelessly chargeable external device or the internal battery is capable of obtaining the power source in a wireless manner or a wired manner according to the efficiency of transmission, so that the power source with higher efficiency is supplied timely.

Another advantage of the invention is to provide a portable power supply device and managing method thereof, wherein the external device is charged in a wired manner or a wireless manner freely to be carried without being fixed in a predetermined place.

Another advantage of the invention is to provide a portable power supply device and managing method thereof, wherein the transmission efficiency is ensured while charging with unidirectional security to protect the power sources.

Another advantage of the invention is to provide a portable power supply device and managing method thereof, wherein the portable power supply device is adapted to provide electrical power to the external device as carried with the external device.

Additional advantages and features of the invention will become apparent from the description which follows, and may be realized by means of the instrumentalities and combinations particular point out in the appended claims.

According to the present invention, the foregoing and other objects and advantages are attained by a portable power supply managing method, adapted to supply electrical power to an external device or a battery, comprising:

I. receiving an electrical charging demand from one of the external device and the battery of the portable power supply device;

II. receiving an input state of electrical power source; and

III. preferentially providing a power supplying path for the external device, and then selectively supplying the external device or the battery with electrical power.

According to one embodiment of the present invention, in the step II, the inputting manner of electrical power includes a wireless input manner and a wired input manner, wherein one of the wireless input manner and the wired input manner is selected to supply electrical power according to the respective power properties of the wired input manner and the wireless input manner.

According to one embodiment of the present invention, in the step II, one of the wireless input manner and the wired input manner is selected as the power source.

According to one embodiment of the present invention, the power source is selected from the wireless input manner and the wired input manner, and the power consumption is selected from one of the external device and the battery.

According to one embodiment of the present invention, the step I further comprises the steps of:

I-1. detecting whether the external device exists;

I-2. if the external device exists, detecting whether the external device has a charging demand, and if the external device is offline, detecting whether the battery has a charging demand; and

I-3. if the external device has a charging demand or the battery has a charging demand, processing the step II, and if neither the external device nor the battery has charging demand, ending the power supply managing method.

According to one embodiment of the present invention, the step II further comprises the steps of:

II-1. determining the input state of electrical power of the wired input manner and the wireless input manner; and

II-2. if the input state exists, selecting one of the wired input manner and the wireless input manner as the input power source; if there is no input state, selecting the battery as the input power source.

According to one embodiment of the present invention, the power source is selected from one of the wireless input manner and the wired input manner, and the power consumption is selected from one of the battery and the external device.

According to the present invention, the foregoing and other objects and advantages are attained by a portable power supply device, adapted for providing electrical power to an external device, comprising:

a control module;

an input module; and

a load module, wherein the input module is adapted to be electrically connected to at least one electrical power source, wherein the input module is controlled by the control module to obtain electrical power to be supplied to the load module, wherein the electrical connection or disconnection from the input module to the load module is controlled by the control module according to the detection of the input module and the load module, so that the external device is power supplied with electrical power from the load module of the portable power supply device.

According to one embodiment of the present invention, the load module is electrically pre-connected to a battery such that the external device is charged with electrical power by the battery of the load module of the portable power supply device.

According to one embodiment of the present invention, the electrical connection or disconnection from the battery of the load module to the connected external device is controlled by the control module according to the detection of the input state of the input module.

According to one embodiment of the present invention, the input module comprises a wired input terminal and a wireless input terminal adapted to connect a wired electrical power source and a wireless electrical power source respectively to provide electrical power to the load module.

According to one embodiment of the present invention, the control module collects the state of the input module terminal, and obtains power information from the wired input terminal and the wireless input terminal, wherein one of the wired input terminal and the wireless input terminal is selected by the control module.

According to one embodiment of the present invention, the load module comprises an internal storage terminal and an external supplied terminal respectively adapted to connect with the battery and the external device, wherein the battery is prefabricated to the internal storage terminal, wherein the battery, controlled by the control module, is charged with electrical power from the internal storage terminal and the input module, wherein the battery, controlled by the control module, supplies electrical power from the internal storage terminal to the external supplied terminal.

According to one embodiment of the present invention, the battery is controllably selected from being charged with electrical power and providing electrical power.

According to one embodiment of the present invention, one of the internal storage terminal and the external supplied terminal is selectively to be connected to the input module.

According to one embodiment of the present invention, the load module comprises an internal storage terminal and an external supplied terminal, respectively adapted to connect with a battery and the external device, wherein the battery is prefabricated to the internal storage terminal, wherein the internal storage terminal, controlled by the control module, is supplied with electrical power from the input module, wherein the external supplied terminal, controlled by the control module, is supplied with electrical power from the input module.

According to one embodiment of the present invention, one of the internal storage terminal and the external supplied terminal is selectively to be electrically connected to the input module, wherein one of the wired input and the wireless input is selected to electrically connect to the load module.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 illustrates perspective views of various charging ports of conventional electrical devices.

FIGS. 2A and 2B are perspective views of the portable power supply device and its power supply managing method according to a preferred embodiment of the present invention, illustrating the supplying of electrical power to an external device.

FIG. 3 is a schematic view illustrating the loading mode of the portable power supply device and its power supply managing method according to the above preferred embodiment of the present invention.

FIG. 4 is a schematic view illustrating the supplying mode of the portable power supply device and its power supply managing method according to the above preferred embodiment of the present invention, illustrating the supplying mode.

FIG. 5 is a flow chart illustrating the loading mode of the power supply managing method according to the above preferred embodiment of the present invention

FIG. 6 is a block diagram of the portable power supply device according to the above preferred embodiment of the present invention.

FIG. 7 is a schematic diagram of the portable power supply device according to the above preferred embodiment of the present invention.

FIG. 8 is an electric circuit diagram illustrating the load execute terminal of the portable power supply device according to the above preferred embodiment of the present invention.

FIG. 9 is an electric circuit diagram illustrating the wireless input of the portable power supply device according to the above preferred embodiment of the present invention.

FIG. 10 is an electric circuit diagram illustrating the load module of the portable power supply device according to the above preferred embodiment of the present invention.

FIG. 11 is an electric circuit diagram of the portable power supply device according to the above preferred embodiment of the present invention.

FIG. 12 is a perspective view of the portable power supply device according to the above preferred embodiment of the present invention, illustrating the connection with the external device.

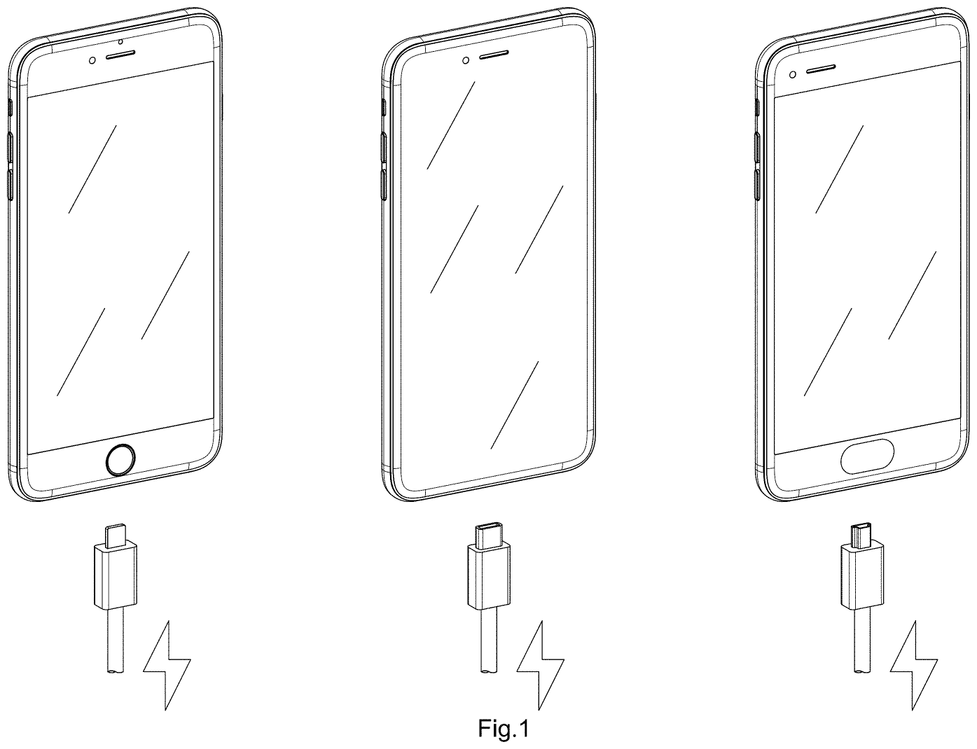

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

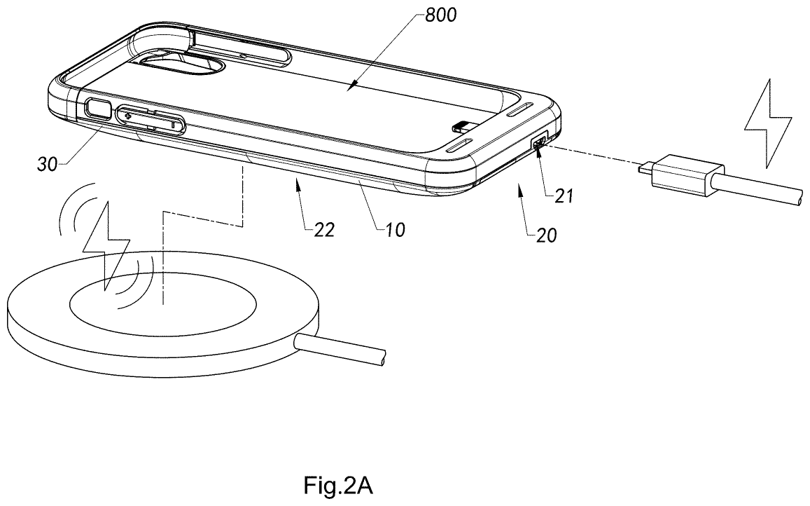

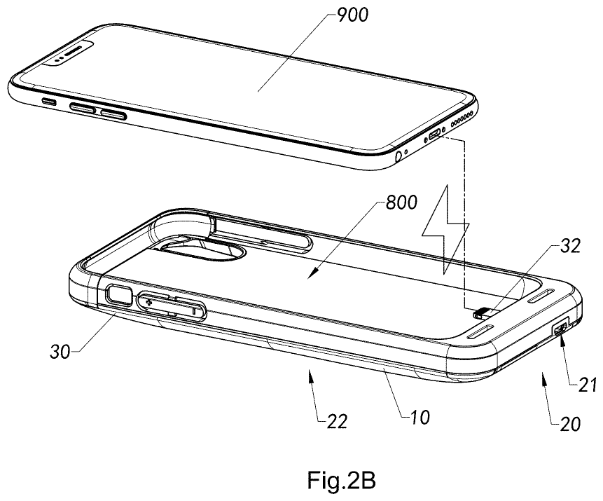

The present invention provides a portable power supply managing method, as shown in FIGS. 2A to 5, adapted for providing electrical power to an external device 900. The power supply managing method is capable of temporarily storing electrical energy by a battery 800 to provide electrical power to the external device 900 at any time as needed. The power supply managing method comprises the following steps:

I. receiving an electrical charging demand from the external device 900 or the battery 800;

II. receiving an input state of electrical power; and

III. preferentially providing a power supplying path for the external device 900, and then selectively charging the external device 900 or the battery 800 with electrical power.

In particular, the power output provided from the power supply managing method is defined as output supply of power correspondingly, and the power input to the power supply managing method is defined as input supply of power. In other words, in accordance with different power consumptions and different input power sources, the power supply managing method automatically provides the power supplying path for charging the external device 900 or the battery 800 with stored electrical power.

Preferably, the power input manner in the step II comprises a wireless input manner and a wired input manner. In other words, the external device 900 may be provided with electrical power in a wired manner or in a wireless manner. Specifically, the battery 800 can stably provide stored electrical power to the external device 900, and there is no need to mount any wireless hardware on the external device 900 nor to provide any corresponding charging port for power inputting for the external device 900.

Firstly, in particular, to process a determination according to the power charging demand or requirement of the battery 800 or the external device 900, wherein it is not necessary to charge power for the external device 900 or the battery 800 that has no charging demand or requirement. The external device 900 or the battery 800 is supplied with protective electrical power. Then, the electrical power inputting state from either the wired input manner or the wireless input manner is received, so as to determine to use a particular power source of the power input or power supply. In other words, the source and application of the electrical power supply are selected and determined mutually from the demand end and supply end. Then, a power supply path is provided according to the states of the demand end and supply end to supply electrical power from high quality power source to the high demanding terminal. Preferably, the external device 900 has a higher priority than the battery 800, and the wired input manner has a higher priority than the wireless input manner. More preferably, one of the wired input manner and the wireless input manner is selected according to their transmission efficiency.

In addition, the step I further comprises the steps of:

I-1. detecting whether the external device 900 exists;

I-2. if the external device 900 exists, detecting whether the external device 900 has an electrical power charging demand, and if the external device 900 is offline, detecting whether the battery 800 has an electrical power charging demand; and

I-3. if the external device 900 or the battery 800 has an electrical power charging demand, processing the step II, and if the external device 900 and the battery 800 have no electrical power charging demand, ending the power supply managing method.

In other words, one of the external device 900 and the battery 800 is selected to be supplied with electrical power. In the preferred embodiment, the external device 900 is a terminal type electrical device needed in daily life. So, the charging demand of the external device 900 is preferentially to be satisfied. Of course, according to different requirements, the battery 800 may also be preferentially selected. It is worth mentioning that, besides the wired manner and the wireless manner for the electrical power supply of the external device 900, the electrical power stored in the battery 800 can also be selected to provide to the external device 900. The type of charging port of the external device 900 does not affect the charging of the electrical power. Regardless of what the charging port type of the external device 900 is, the external device 900 can be supplied with electrical power in a wireless manner or a wired manner. The electrical power stored in the battery 800 in a wireless manner or a wired manner can also be supplied to the external device 900.

Furthermore, the step II further comprises the steps of:

II-1. determining the input states of electrical power of the wired input manner and the wireless input manner; and

II-2. if the input state exists, selecting one of the wired input manner and the wireless input manner as the input power source; if not, selecting the battery 800 as the input power source.

In other words, when there is electrical power inputting through anyone of wireless input manner and the wired input manner, the performance of the inputting electrical power, such as transmission efficiency, voltage stability, current stability, and etc., is detected and analyzed for determination and selection of one of the wireless input manner and the wired input manner as the power source. It is worth to mention the step II-2 not only selects one input manner, but also rejects the other non-selected input manner. In other words, the wired input and the wireless input would not interact with each other so as to prevent intrusion from the wired input to the wireless input. More preferably, the performance of the wired input and the wireless input are detected in a real time manner. That is to say, the step II is executed in a regular cycling manner to ensure the reliability and timeliness of the input power source.

In particular, the external device 900 does not need to be equipped with an extra wireless charging device. In the preferred embodiment, the electrical power obtained in the wireless manner is stored in the battery 800, and while the battery 800 is carried with the external device 900, the external device 900 may obtain electrical power from the battery 800.

It is worth mentioning that when there is no power input in the wired manner or the wireless manner, the external device 900 is capable of obtaining the stored energy from the battery 800. In other words, according to the preferred embodiment, the external device 900 is capable of obtaining the necessary power energy from various power sources. For the external device 900, the power supply managing method enables a timely and immediate power supply to the external device 900. Moreover, the external device 900 does not require to be fixed in a specific location for power charging according to the power supply managing method of the present invention, wherein the external device 900 is able to be charge for electrical power anywhere anytime to fulfill the power consumption of the external device 900.

In particular, the operation for providing electrical power to the battery 800 or the external device 900 from the external power source is defined as a loading mode. The operation for providing electrical power to the external device 900 from the battery 800 is defined as a supplying mode. During the loading mode, the source of electrical power to be inputted is from the external power source, selecting one of the wired input manner and the wireless input manner, for supplying to one of the battery 800 and the external device 900. During the supplying mode, the source of electrical power to be inputted is from the battery 800, for supplying to the external device 900. No matter in the loading mode or the supplying mode, the power inputting path of the electrical power is one-way, one-direction and irreversible. The selection of demand end and the supply end through the power supply managing method is an alternative determination, wherein a regular re-execution of the power supply managing method will re-determine and re-select the demand end and the supply end again, while each re-execution will not conflict with the last execution, so the electrical power will not backflow along the path to prevent intrusion.

It is worth mentioning that the power supply managing method of the preferred embodiment has an anti-backflow function to prevent the wireless input from being accidentally damaged by intrusion of the wired input. Meanwhile, the power supply managing method has a function that supports both wired and wireless power charging, adapted to provide electrical power for external devices 900 with different types of charging ports. According to the charging requirement of the external device 900, the power supply managing method has a priority of external charging function as well as a highly reliable compatible and recognition function. The battery 800 is also adapted for using high-voltage battery cell with larger capacity that fulfills a good operating foundation of hardware design.

The working and operating process of a charger processing the power suppl managing method of the present preferred embodiment is described as example to illustrate the operation of the power supply management method in the following. When a wireless charger or a wired charger is connected, a micro control unit (Microcontroller Unit, MCU) detects the input voltage while the power charging circuit control switch is turned on and entering a charging state, and detects whether there is overvoltage or undervoltage of the input voltage in a real time manner. After disconnecting with the charger, the battery 800 enters a low power standby state. When an external button is pressed for 1.5 seconds, the battery 800 turns on to output power and the MCU is real-time monitoring whether the voltage of the battery cell is undervoltage, wherein if the voltage of the battery cell is undervoltage, the power output is stopped and the battery 800 enters the low power standby state. When the button is clicked, the power level of the battery is displayed for 6 seconds and then the display is off. During the discharging of the battery 800, the MCU is real-time monitoring the output current that, when the output is overcurrent or in low current, the output is stopped and the battery 800 enters the low-power standby state.

Moreover, the present invention further provides a portable power supply device, as shown in FIG. 2A to FIG. 12, which comprises a control module 10, an input module 20 and a load module 30, wherein the input module 20 is adapted to be connected to an electric power source and the load module 30 is adapted to be connected to a device needed to be charged. The control module 10 controls the connection/disconnection between the input module 20 and the load module 30 according to corresponding detection so as to supply electrical power to the device needed to be charged accordingly. In the preferred embodiment, the load module 30 is electrically pre-connected with the battery 800. In other words, the battery 800, as the device needed to be charged, is capable of being charged with electrical power from the input module 20 and storing such electrical power for charging the external device 900 the electrical power upon its demand or requirement. The external device 900 can be electrically and detachably connected with the load module 30 and supplemented with energy from the input module 20 or the battery 800 under the controlling of the control module 10.

Preferably, in one embodiment, the control module 10 is preloaded and programmed with the power supply managing method as described above. According to the monitoring and detection of the states of the load module 20, the control module 10 controls the electrical connection/disconnection between the input module 20 and the load module 30 as well as between the battery 800 connected with the load module 30 and the external device 900.

In the preferred embodiment, the connection path between the external device 900 and the battery 800 connected with the load module 30 is controlled by the control module 10 in a one-way manner. In detail, the control module 10 comprises a detect unit 11 and an execute unit 12, wherein the detect unit 11 is capable of receiving information regarding the states of the input module 20 and the load module 30, wherein according to information of the detect unit 11, the execute unit 12 controls the connection/disconnection between the input module 20 and the load module 30 as well as between the external device 900 and the battery 800 connected with the load module 30. In other words, the electrical connection path between the demand end and the supply end are respectively detected and controlled by the control module 10. The control module 10 receives external commands and controls correspondingly the electrical connection and disconnection between the input module 20 and the load module 30, as well as the electrical connection and disconnection between the external device 900 and the battery 800 connected with the load module 30, so as to supply electrical power according to actual and specific needs and requirements.

More specifically, the input module 20 comprises a wired input terminal 21 and a wireless input terminal 22 adapted to connect and input electrical power in a wired manner and in a wireless manner respectively. The detect unit 11 detects the wired input terminal 21 and the wireless input terminal 22 and receives respective performance parameters of the inputting electrical power through the wired input terminal 21 and the wireless input terminal 22. The detect unit 11 of the control module 10 collects information regarding the states and conditions of the input module 20, i.e., in particular, the parameters of the electrical power from the wired input terminal 21 and the wireless input terminal 22. After analysis and determination, the execute unit 12 selects and executes a single voltage input through the load module 30.

The load module 30 comprises an internal storage terminal 31 and an external supplied terminal 32 adapted to be connected with the battery 800 and the external device 900 respectively. In the preferred embodiment, the battery 800 is pre-connected to the internal storage terminal 31 electrically under controlled by the control module 10. The external device 900 is detachably connected to the external supplied terminal 32 electrically and the external device 900 is provided with electrical power from the external supplied terminal 32 under the control of the control module 10. In other words, the battery 800 of the power supply device can be charged and thus provides electrical power to the external device 900. The wired input terminal 21 and the wireless input terminal 22 of the power supply device are both capable of supplying electrical power to the external device 900, wherein the type of charging port of the external device 900 has no limitation that the external device can charged for supplying electrical power in both the wired manner and the wireless manner. Especially, the external device 900 can enjoy wireless power supply any time.

It is worth mentioning that the type of the charging port of the external device 900 does not affect the way of power charging thereof. The wired input terminal 21 of the input module 20 of the power supply device enables effective power supplying from external power source, wherein the inputted electrical power of the input module 20 or the battery 800 may all supply to the external device 900 to use.

The control module 10 of the portable power supply device has preset with two operating modes, including a loading mode 100 and a supplying mode 200, wherein during the loading mode 100, the external device 900 is electrically connected to the external supplied terminal 32, and the control module 10 preferentially connects the power supplying path between the input module 20 and the external device 900, wherein during the supplying mode 200, the control module 10 connects the power supplying path between the internal storage terminal 31 and the external supplied terminal 32 of the load module 30, so as to input and charge the external device 900 with electrical power from the internal battery 800. Accordingly, the external device 900 can be charged in different modes, embodied as either the loading mode 100 or the supplying mode 200, in a timely manner.

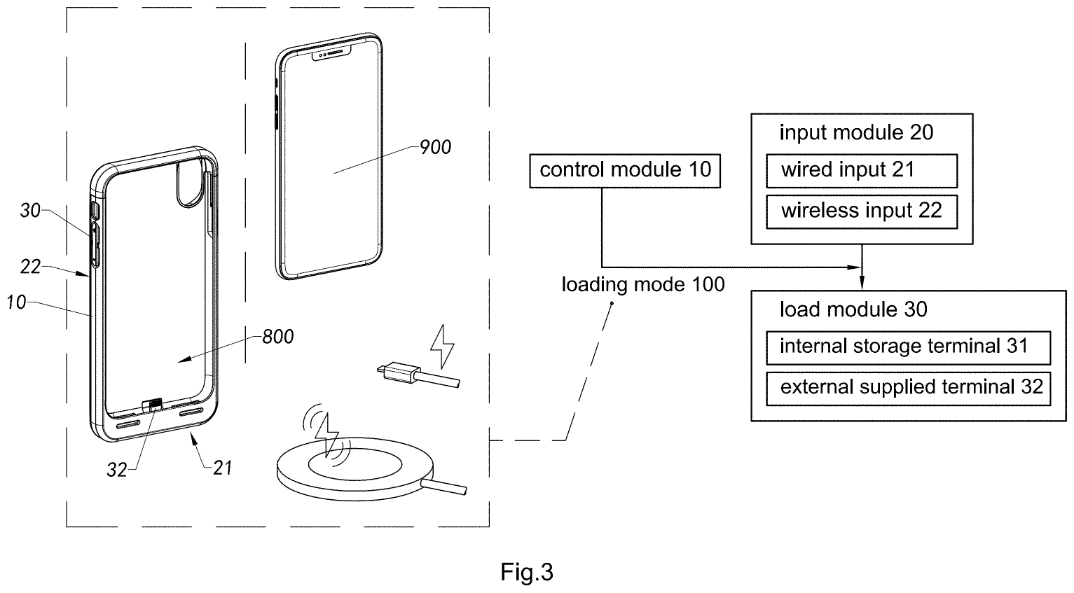

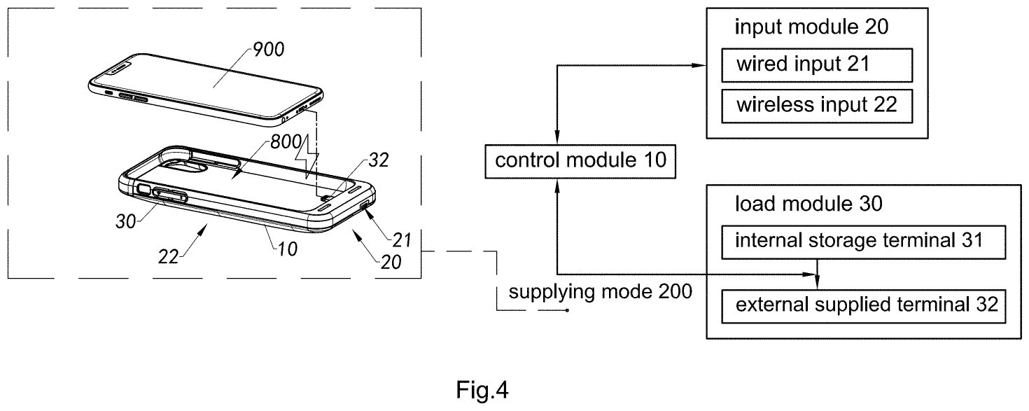

In particular, the loading mode 100 and the supplying mode 200 are illustrated in FIG. 3 and FIG. 4, wherein for the convenience of explanation, for example, the external device 900 is embodied as a smartphone. The execute unit 12 of the control module 10 comprises a mode execute terminal 121, wherein the loading mode 100 and the supplying mode 200 are switched by the mode execute terminal 121. Preferably, according to the preferred embodiment, the mode execute terminal 121 is controlled to connect the power supplying path between the internal storage terminal 31 and the external supplied terminal 32 of the load module 30, that is switched to the supplying mode 200. When the mode execute terminal 121 is controlled to disconnect the power supplying path between the internal storage terminal 31 and the external storage terminal 32 of the load module 30, the mode execute terminal 121 is controlled to connect the power supplying path between the input module 20 and the load module 30. In other words, the mode execute terminal 121 is controlled to connect the power supplying path between the internal storage terminal 31 and the external supplied terminal 32 and switch to the supplying mode 200.

In the preferred embodiment, if the mode execute terminal 121 is turned on, then the power supply device is in the supplying mode 200; if the mode execute terminal 121 is not turned on, then the power supply device is in the loading mode 100. Preferably, during the supplying mode 200, unless the mode execute terminal 121 is turned on, the control module 10 disconnects the other power supplying path, leaving the mode execute terminal 121 as the only connection path, ensuring the uniqueness that the electrical power can only be obtained via the external supplied terminal 32 to prevent other interference. More preferably, the inputting detection of the input module 20 is conducted by the detect unit 11 of the control module 10, if the input module 20 is determined for unable to supply electrical power to the external device 900 connected with the external supplied terminal 32, the supplying mode 200, as shown in FIG. 4, is selected by the mode execute terminal 121.

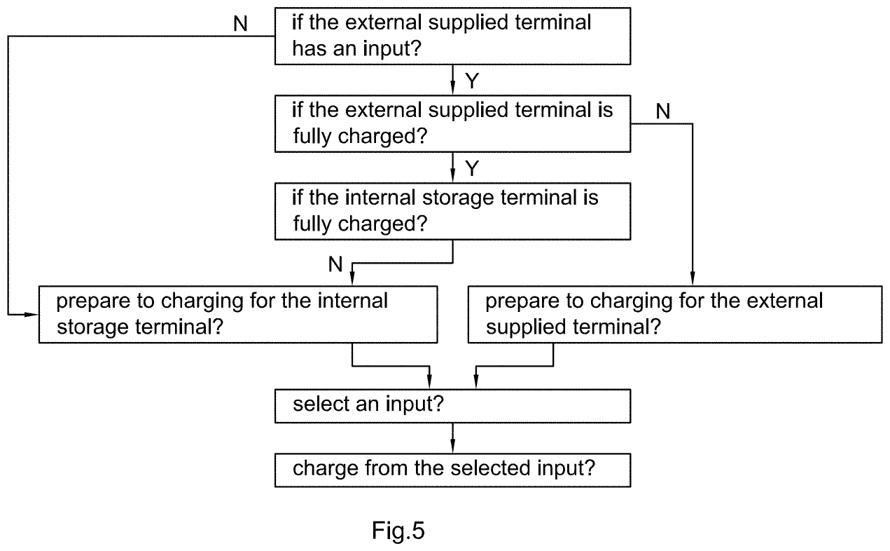

As shown in FIGS. 3 and 5, the flow chart of the loading mode 100 is specifically illustrated. During the loading mode 100, the internal storage terminal 31 or the external supplied terminal 32 is supplied with electrical power from the wired input terminal 21 or the wireless input terminal 22 of the input module 20. The input module 20 is detected by the control module 10 for determining whether supplying electrical power through the wired input terminal 21 or the wireless input terminal 22 of the input module 20. The internal storage terminal 31 or the external supplied terminal 32 of the load module 30 is also detected by the control module 10 for determining whether supplying electrical power through the internal storage terminal 31 or the external supplied terminal 32. In other words, the detect unit 11 of the control module 10 processes detection for both the input module 20 and the load module 30 in order to merely select one power supplying path connecting between the input module 20 and the load module 30.

FIG. 5 is a flow chart illustrating the control module 10 during the load mode 100. Firstly, determine whether the external supplied terminal 32 is connected with and has an input from the external device 900. If there is no the external device 900, prepare to charge electrical power for the internal storage terminal 31. If there is the external device 900, then continue the next step, that is to determine whether the external device 900 is fully charged with electrical power or not, i.e. to determine the charging demand state of the external device 900. If the external device 900 is fully charged, then continue to determine whether the battery 800 connected to the internal storage terminal 31 is fully charged or not. If the battery 800 is not fully charged yet, then prepare to charge electrical power to the internal storage terminal 32. If the external device 900 is not fully charged yet, then prepare to supply electrical power to the external device 900. In other words, the above-mentioned process illustrates the selection of the internal storage terminal 31 or the external supplied terminal 32.

Secondly, select the wired input terminal 21 or the wireless input terminal 22 of the input module 20.

Finally, connect the power supplying path according to the above selection in the input module 20 and in the load module 30 to supply electrical power from the selected input terminal to the selected load terminal.

Alternatively, the step of determining the input module 20 may be processed as the first step of this process. That is, firstly, make selection of the wired input terminal 21 or the wireless input terminal 22 of the input module 20, and secondly, make selection of the internal storage terminal 31 or the external supplied terminal 32 of the load module 30.

In addition, the selection of the wired input terminal 21 or the wireless input terminal 22 of the input module 20 and the selection of the internal storage terminal 31 or the external supplied terminal 32 of the load module 30 may also be processed in simultaneously.

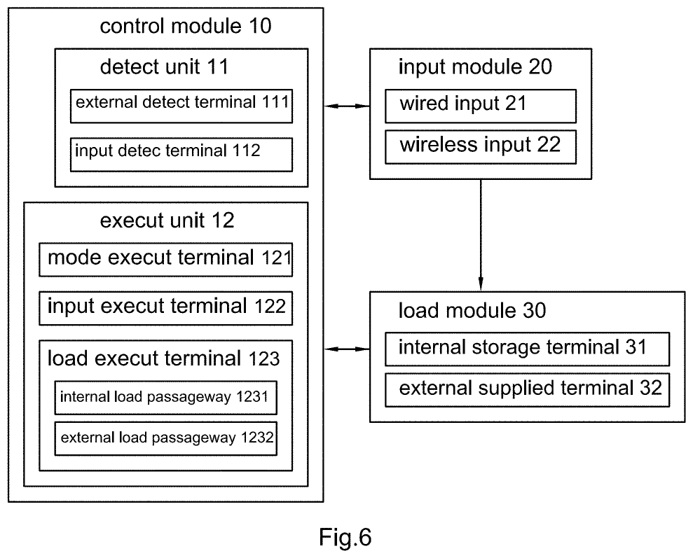

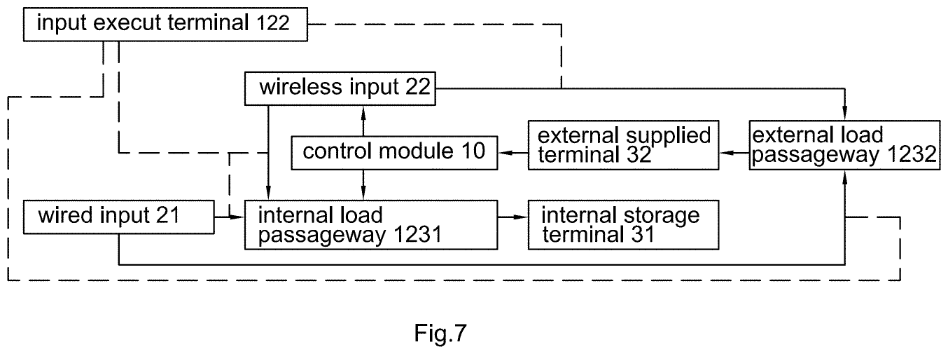

Specifically, as shown in FIG. 6 and FIG. 7, the detect unit 11 comprises an external detect terminal 111 and an input detect terminal 112. The external detect terminal 111 is electrically connected to the external supplied terminal 32 to detect whether the external device 900 is fully charged or not. The input detect terminal 112 is electrical connected to the input module 20 to detect the power supplying states of the wired input terminal 21 and the wireless output 22. Preferably, the execute unit 12, based on the detection result from the input detect terminal 112, selects the one having higher power to supply electrical power. For example, the wired input terminal 21 is not connected to an external power source, the power supply performance of the wireless input terminal 22 is detected by the input detect terminal 112 and the execute unit 12 selects the wireless input terminal 22 to supply electrical power.

The execute unit 12 further comprises an input execute terminal 122 and a load execute terminal 123 electrically connected with the input execute terminal 122. During the loading mode 100, the input execute terminal 122 is selected to connect with one of the wired input terminal 21 and the wireless input terminal 22, and the load execute terminal 123 is selected to connect with one of the internal storage terminal 31 and the external supplied terminal 32. After selection of the input execute terminal 122 and the load execute terminal 123, the input module 20 is electrically connected with the load module 30, wherein the internal storage terminal 31 or the external supplied terminal 32 of the load module 30 is capable of being supplied with electrical power from the wired input terminal 21 or the wireless input terminal 22.

It is appreciated that, during the loading mode 100, based on the selection of the input execute terminal 122, the wired input terminal 21 and the wireless input terminal 22 are impossible to be connected with each other. Similarly, based on the selection of the load execute terminal 123, the internal storage terminal 31 and the external supplied terminal 32 are impossible to be connected with each other. Accordingly, while the wired power source and the wireless power source are both provided for power supply, the wired power source is prevented from back flowing to the wireless power source that substantially improves the reliability of the circuit. It prevents the battery 800 from being supplied with electrical power and outputting electrical power simultaneously while both the battery 800 and the external device 900 are needed to be charged at the same time, so as to avoid adverse effects on the battery 800.

In other words, the battery 800 is being charged with electrical power during the loading mode 100 and is outputting electrical power as a power source during the supplying mode 200.

In addition, according to the detection of input module 20 by the input detect terminal 112, the input execute terminal 122 may select to shut down all inputting power voltage. For example, after the input detect terminal 112 has detected the electrical power performance of the wired input terminal 21 or the wireless input terminal 22, if the wired input terminal 21 or the wireless input terminal 22 has any overvoltage or undervoltage condition, the input execute terminal 122 will disconnect the connection with the input module 20, so as to ensure no usage of any bad electrical energy to avoid any adverse effect to the load module 30. Preferably, when the input detect terminal 112 detects that the input module 20 is able to provide good electrical power, the control module 10 is switched to supplying mode 200. Further, preferably, when the input detect terminal 112 detects the input module 20 fails to provide good electrical power while the external device 900 is not effectively connected thereto, such as there is no external device 900 being connected thereto or the external device 900 is offline, the control module 10 ends the power supplying.

In the preferred embodiment, during the supplying mode 200, the input execute terminal 122 and the load execute terminal 123 are operated to disconnect the electrical connection between the input module 20 and the load module 30. The mode execute terminal 121 is switched for electrically connecting the internal storage terminal 31 to the external supplied terminal 32 of the load module 30 in a unique and one-way manner.

More specifically, the load execute terminal 123 comprises a load execute path 1231 and an external load path 1232. The control module 10 selects the internal storage terminal 31 as the only electrical power receiving terminal through further connecting the input execute terminal 122 with the load execute path 1231. The control module 10 selects the external supplied terminal 32 as the only electrical power receiving terminal through further connecting the input execute terminal 122 with the external load path 1232.

As shown in FIG. 7, the input module 20 supplies electrical power to the input detect terminal 112. According to the detected information of the input detect terminal 112, the input execute terminal 122 determines and selects the wired input terminal 21 or the wireless input terminal 22 to use. According to the detected information of the external detect terminal 111 from the external supplied terminal 32, the load execute terminal 123 determines to connect with the load execute path 1231 or the external load path 1232. When both the external device 900 and the battery 800 have electrical power charging demands, the control module 10 preferentially considers connecting the electrical power supplying path between the input module 20 and the external supplied terminal 32 for power supplying so as to ensure the external device 900 is preferentially charged.

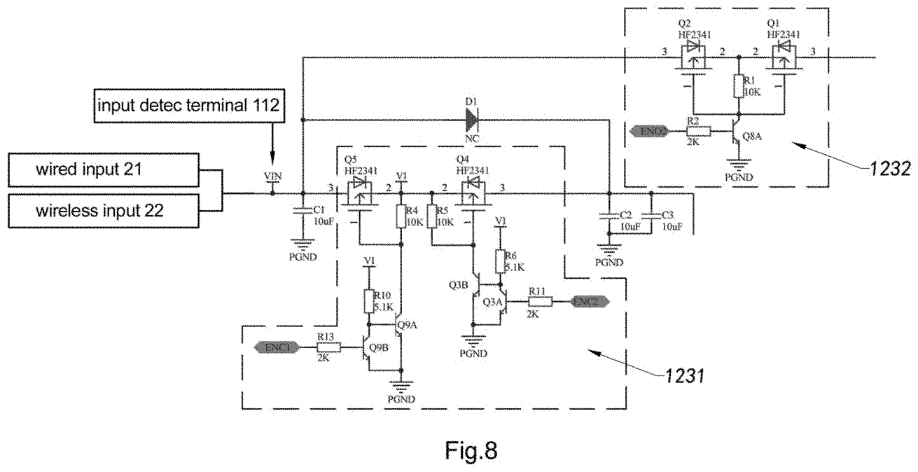

FIG. 8 illustrates one mode of the load execute circuit according to the preferred embodiment. During the loading mode 100, it is embodied that the control module 10 determines firstly the state of power demand and then the state of the power supply. The external detect terminal 111 detects whether the external device 900 is connected or not, and then determines whether the external device 900 has a power demand and whether it is required to connect with the external supplied terminal 32. The input detect terminal 112 detects the power levels of the wired input terminal 21 and the wireless input terminal 22. The input execute terminal 122 selects to connect to either the wired input terminal 21 or the wireless input terminal 22. The power source is determined according to the information of the input detect terminal 112 while only one of the wired input terminal 21 and the wireless input terminal 22 is selected to be the only one of the power source, so that the electrical power from the wired input terminal 21 will not backflow to the wireless input terminal 22.

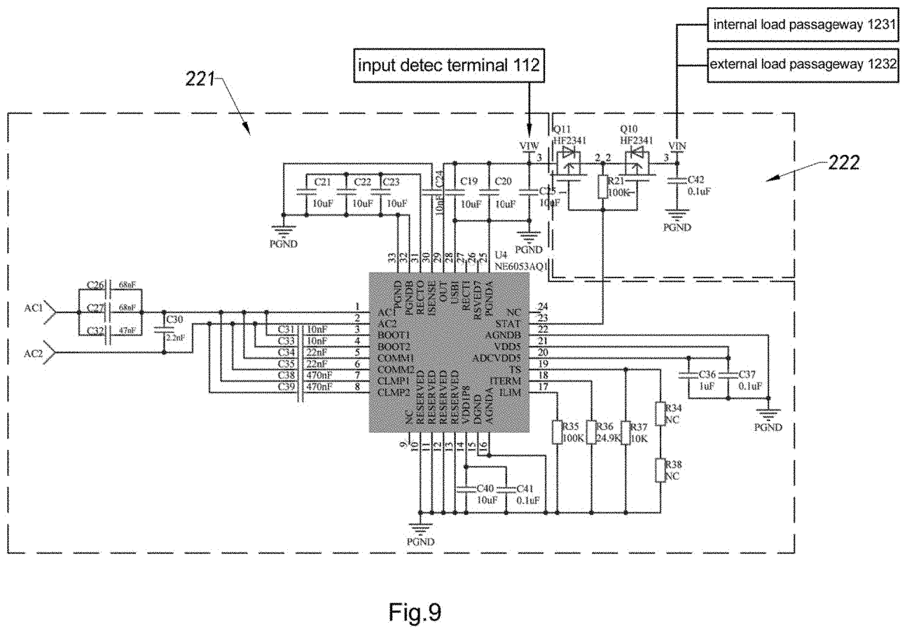

FIG. 9 illustrates an alternative mode of the wireless input circuit according to the preferred embodiment. During the loading mode 100, when the input detect terminal 112 determines that the wireless input terminal 22 is adapted to supply electrical power, the input execute terminal 122 selects to connect the wireless input terminal 22 to the load execute path 1231 or the external load path 1232. In other words, the external device 900, which does not have to be built-in or equipped with any wireless charging hardware or component, is capable of being supplied with stored electrical power from the wireless input terminal 22 which is able to receive electrical power and stored in the battery 800 so as to enable the external device 900 being charged wirelessly.

In particular, the wireless input terminal 22 comprises a wireless receiving unit 221 and a wireless loading unit 222. External electrical power from an external power source is received through the wireless receiving unit 221 wirelessly and transmitted by the wireless loading unit 222 to the load execute path 1231 or the external load path 1232 of the load execute terminal 123 in a one-way manner. In other words, the electrical power cannot be transmitted from the load execute path 1231 or the external load path 1232 to the wireless receiving unit 221 of the wireless input terminal 22 through the wireless loading unit 222, so as to ensure the one-way reception and transmission of the electrical power of the wireless receiving unit 221.

Furthermore, if the electrical power is determined to be supplied to the external device 900, it is supplied from the external load path 1232 to the external supplied terminal 32. If the electrical power is determined to be supplied to the battery 800, it is supplied from the load execute path 1231 to the internal storage terminal 31.

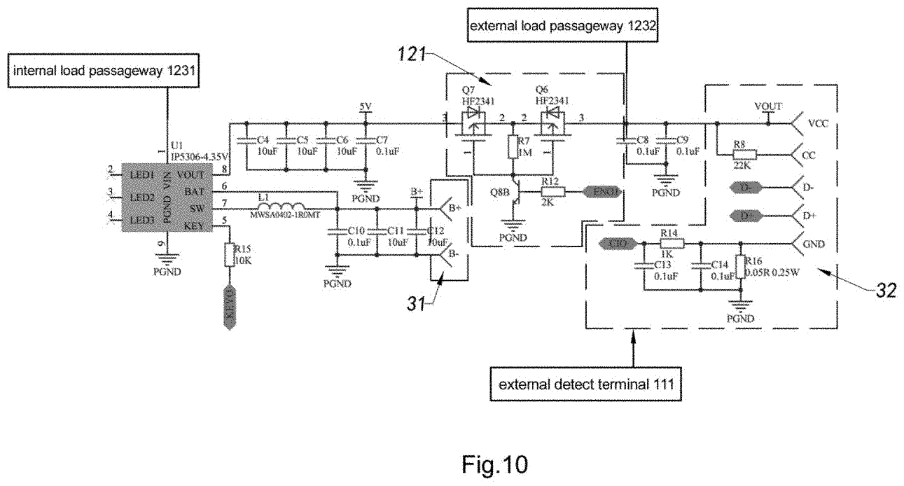

FIG. 10 illustrates another alternative mode of the load module circuit according to the preferred embodiment. During the supplying mode 200, the electrical power stored in the battery 800 is supplied to the external device 900 through the connected mode execute terminal 121. During the loading mode 100, the external supplied terminal 32 is supplied with electrical power from the load execute path 1231 of the load execute terminal 123, and the internal storage terminal 31 is supplied with electrical power from the external load path 1232 of the load execute terminal 123.

Furthermore, the external detect terminal 111 detects whether the external device 900 is connected and whether there is a charging demand. In one embodiment, in view of the external device 900, the loading mode 100 is preferentially used to charge electrical power from the input mode 20, and then the supplying mode 200 is used to charge electrical power from the battery 800. In view of the battery 800, the input mode 20 is preferentially to be selected to be charged with electrical power and then to supply the stored electrical power in the battery 800 to the external device 900.

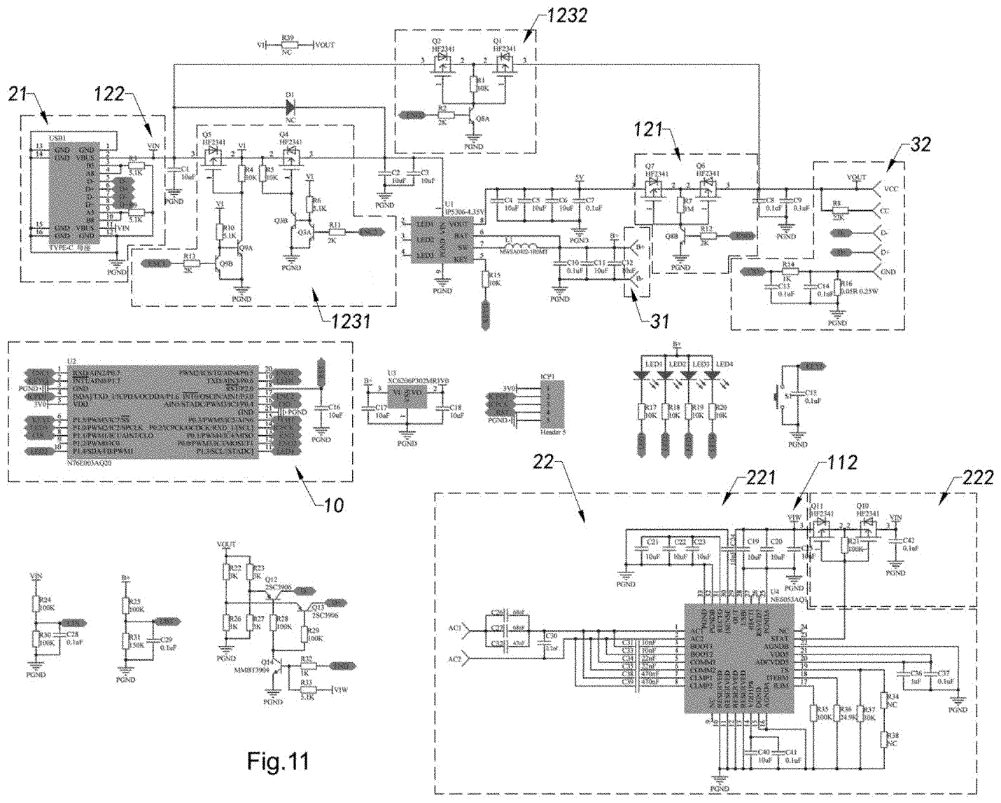

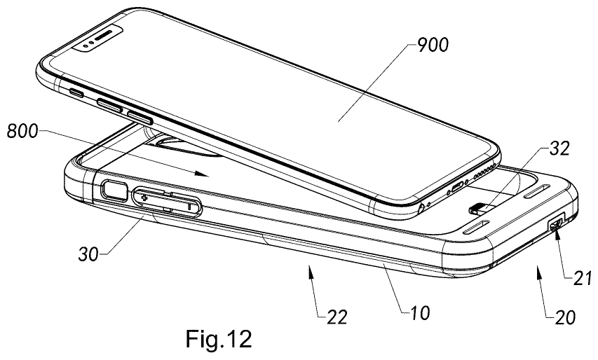

FIG. 11 is a circuit diagram illustrating the power supply device according to the preferred embodiment. FIG. 12 illustrates the power supply device connected with the external device 900 for use. The control module 10 is selected as the power source for the external device 900 through the mode execute terminal 121. And, the input execute terminal 122 determines whether a wired manner or a wireless manner is used to obtain external electrical power. In the preferred embodiment, the external supplied terminal 32 is implemented as a charging port. In another embodiment, the external supplied terminal 32 is implemented as a wireless detection port. There is no influence on the management and control of the power supply of the present invention. The present invention can provide a supplemental electrical power supply to external devices 900 having different types of charging ports while fulfill the charging demand and requirement of the external devices 900. The present invention can provide a supplemental portable electrical power supply to the wirelessly chargeable external device 900 without requiring the external device to be fixed and maintained in a particular location. The present invention can provide electrical power in a wireless manner for the external device 900 without wireless charging ability, while updating or modifying the charging hardware of the external device 900.

During the loading mode 100, the external power source provides power supply to the load module from the input module 20. If it is a wirelessly chargeable external power source, the output voltage the wireless input terminal 22 is 5V, wherein the wireless receiving unit 221 receives the external electrical power and transmits the voltage to the input detect terminal 112. If the input execute terminal 122 determines that the electrical power from the wirelessly chargeable external power source performs better than a wired manner, the input execute terminal 122 transmits the voltage to the external load path 1232 to supply to the external supplied terminal 32.

When the control module 10 detects the external device 900 being fully charged through the external supplied terminal 32, the external load path 1232 is closed and the load execute path 1231 is opened, so that the electrical power from the input module 20 is transmitted to the internal storage terminal 31.

The wirelessly chargeable external device 900 or the internal battery 800 can be charged with electrical power from the power source having the higher efficiency selected from in the wired manner or the wireless manner in a timely manner.

Similarly, when the external power source is in the wired manner, the wired input terminal 21 outputs electric voltage to the input detect terminal 112. The input execute terminal 122 determines whether the wired manner or the wireless manner has a better electrical power performance and the input execute terminal 122 transmits the voltage to the external load path 1232 and then supplies to the external supplied terminal 32. Specifically, the wired input terminal 22 would not output voltage back to the wireless input terminal 22 through the input execute terminal 122. In addition, the wireless loading unit 222 has a unidirectional electrical voltage path for preventing interference of output voltage from the wired input terminal 21 to the wireless receiving unit 221, so as to ensure the unidirectional safety of power consumption while ensuring the power transmission efficiency.

As shown in FIG. 12, by means of the power supply device of the present invention, the external device 900 can selectively be supplied with electrical power through wireless manner or in the wired manner. The power supply is reasonably provided with a selection between the wireless manner and the wired manner while there is no interference therebetween and prevention of any backflowing between each other, so as to enhance the adaptability of the power source in a wired manner or a wireless manner. The external device 900 has no need to be fixed to a predesignated location in order to be charged in a wired manner or a wireless manner. The portable power supply device of the present invention is also preferred to have a back-mounting configuration adapted to be mounted to the back side of the external device 900 so as to enable the external device 900 to be supplied with electrical power portably and movably.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention comprises all modifications encompassed within the spirit and scope of the following claims.

What is claimed is:

1. A portable power supply managing method for supplying electrical power to an external device or a battery, comprising:
(I) receiving an electrical charging demand from one of the external device and the battery;
(II) receiving an input state of electrical power; and
(III) preferentially providing a power supplying path for the external device and then selectively supplying one of the external device and the battery with electrical power.

2. The portable power supply managing method, as recited in claim 1, wherein, in the step (II), a wireless input manner and a wired input manner are provided for inputting of electrical power, wherein one of the wireless input manner and the wired input manner is selected to be supplied with electrical power according to power properties of the wired input manner and the wireless input manner.

3. The portable power supply managing method, as recited in claim 1, wherein, in the step (II), one of the external device and the battery is selected to be supplied with electrical power.

4. The portable power supply managing method, as recited in claim 2, wherein one of the wireless input manner and the wired input manner is selected as a power source and one of the external device and the battery is selected as an energy consumption.

5. The portable power supply managing method, as recited in claim 1, wherein the step (I) further comprises the steps of:
(I-1) detecting whether the external device exists;
(I-2) if the external device exists, detecting whether the external device has a charging demand, and if the external device is offline, detecting whether the battery has a charging demand; and
(I-3) if one of the external device and the battery has the charging demand, processing the step (II), and if neither the external device nor the battery either has the charging demand, ending the power supply managing method.

6. The portable power supplying managing method, as recited in claim 2, wherein the step II further comprises the steps of:
(II-1) determining the input state of electrical power of the wired input manner and the wireless input manner; and
(II-2) if the input state exists, selecting one of the wired input manner and the wireless input manner as input power source; if not, selecting the battery as input power source.

7. The portable power supplying managing method, as recited in claim 5, wherein the step II further comprises the steps of:
(II-1) determining the input state of electrical power of the wired input manner and the wireless input manner; and
(II-2) if the input state exists, selecting one of the wired input manner and the wireless input manner as input power source; if not, selecting the battery as input power source.

8. The portable power supply managing method, as recited in claim 6, wherein one of the wireless input manner and the wired input manner is selected as a power source and one of the external device and the battery is selected as an energy consumption.

9. The portable power supply managing method, as recited in claim 7, wherein one of the wireless input manner and the wired input manner is selected as a power source and one of the external device and the battery is selected as an energy consumption.

10. A portable power supply device for providing electrical power to an external device, comprising:
a control module;
an input module; and
a load module, wherein the load module is adapted for electrically connecting to an electrical power source, wherein the input module is controlled by the control module to obtain electrical power to be supplied to the load module, wherein an electrical connection or disconnection from the input module to the load module is controlled by the control module according to a detection of the input module and the load module, so that the external device is supplied with electrical power to the load module of the portable power supply device.

11. The portable power supply device, as recited in claim 10, wherein the load module is electrically pre-connected to a battery such that the external device is charged with electrical power by the battery of the load module of said portable power supply device.

12. The portable power supply device, as recited in claim 11, wherein the electrical connection or disconnection from the battery of said the module to the external device connected thereto is controlled by the control module according to a detection of an input state of the input module.

13. The portable power supply device, as recited in claim 10, wherein said input module comprises a wired input terminal and a wireless input terminal adapted for connecting a wired electrical power source and a wireless electrical power source respectively to provide the load module with electrical power.

14. The portable power supply device, as recited in claim 13, wherein the control modules collect an input state of the input module, and obtains power information from the wired input terminal and the wireless input terminal, wherein one of the wired input terminal and the wireless input terminal is selected by the control module.

15. The portable power supply device, as recited in claim 12, wherein the load module comprises an internal storage terminal and an external supplied terminal adapted for connecting with the battery and the external device respectively, wherein the battery is prefabricated to the internal storage terminal, wherein the battery, controlled by the control module, is charged with electrical power from the internal storage terminal and the input module, wherein the battery, controlled by the control module, supplies electrical power from the internal storage terminal to the external supplied terminal.

16. The portable power supply device, as recited in claim 15, wherein the battery is controllably selected from being charged with electrical power and providing electrical power.

17. The portable power supply device, as recited in claim 15, wherein one of the internal storage terminal and the external supplied terminal is selectively to be connected to the input module.

18. The portable power supply device, as recited in claim 13, wherein the load module comprises an internal storage terminal and an external supplied terminal adapted for connecting with the battery and the external device respectively, wherein the battery is prefabricated to the internal storage terminal, wherein the battery, controlled by the control module, is charged with electrical power from the internal storage terminal and the input module, wherein the battery, controlled by the control module, supplies electrical power from the internal storage terminal to the external supplied terminal.

19. The portable power supply device, as recited in claim 18, wherein the battery is controllably selected from being charged with electrical power and providing electrical power.

20. The portable power supply device, as recited in claim 18, wherein one of the internal storage terminal and the external supplied terminal is selectively connected to the input module, wherein one of the wired input and the wireless input is selected to connect to the load module.
